(19) United States
(12) Patent Application Publication
(10) Pub. No.: US 2024/0248013 A1
(43) Pub. Date: Jul. 25, 2024

(54) Container for Processing and Embedding Histological Samples

(71) Applicant: Eleonora ljinichna Tjan, St. Petersburg (RU)

(72) Inventor: Eleonora ljinichna Tjan, St. Petersburg (RU)

(21) Appl. No.: 18/289,898

(22) PCT Filed: May 13, 2021
(86) PCT No.: PCT/RU2021/000195

§ 371 Date: Nov. 8, 2023

(51) Int. Cl. G01N 1/31; G01N 1/36

(52) U.S. Cl. CPC G01N 1/31; G01N 1/36

(57) ABSTRACT

The invention relates to devices for preparing histological and biological samples for microscopic examination. The present container is designed to be stackable in such a way as to permit treatment fluids to enter a stack, and comprises a housing having a frame that connects to a base with a depression for receiving a sample, and also a removable cover in the form of a histology cassette having a frame covered with a permeable elastic material. The frame of the container housing is made of a resilient material that is deformable under compression. Two opposing sides of the frame of the housing form lateral walls that extend upwards and downwards from the join line with the base, wherein the height of said walls exceeds the total value of the depth of the sample-receiving depression, the thickness of the bottom of the sample-receiving depression and the thickness of the container cover by not less than 0.1 mm. Configured on the upper and lower edges of the lateral walls of the base is a lock assembly, elements of which enter into engagement with elements of the lock assembly of the next lower container when stacked. The object of the container is to allow efficient processing and infiltration of histological and biological samples and subsequent embedding to form blocks for microtoming.

### CROSS REFERENCE TO RELATED APPLICATIONS

This application is the U.S. national stage of International Application No. PCT/RU2021/000195, filed on 2021 May 13.

### BACKGROUND

The invention relates to devices for preparing histological and biological samples for microscopic examination.

Tissue samples taken for examination, before they can be microtomized, should be fixed with an aqueous or aqueous-alcoholic solution of formaldehyde, then dehydrated with a liquid miscible with water, then cleared with an organic liquid well miscible with a dehydrating liquid and paraffin (or other wax), and then impregnated with melted paraffin or other wax.

For microtoming, a paraffin-impregnated sample should be mounted in a special microtome holder. And in order to secure the sample in a conventional microtome holder, it should be placed into a paraffin block. The paraffin is cut along with the sample, and the resulting sections are then straightened in water and placed on a microscopic slide. Forming a paraffin block is a separate procedure. A dehydrated and paraffinized histological sample is placed into a mold of the appropriate size oriented so that the part of the sample intended for examination is pressed to the bottom of the mold, the mold is filled with paraffin and covered, typically with a labeled cassette where the sample was held during dehydration and paraffinization, removing the cassette cover. The cassette becomes a block holder for mounting in a microtome.

The block forming operation is called embedding, and to perform the operation, special embedding devices are used, including a vessel with molten paraffin, heated containers for molds and sample cassettes, and a cooled surface to complete the block formation.

The drawbacks of the common embedding procedure include its labor intensity, lack of ergonomics, and chemical hazards for the personnel (evaporation of residual clearing liquid, i.e., xylene), as well as possible errors in the cassette numbering when transferring samples.

Attempts to automate the embedding process have been made repeatedly. To automate the process, two conditions should be met: the sample should be located at the bottom of the mold in order to be at its top in the block, and it should be oriented in a certain way to obtain sections.

The key element for auto-embedding is the container that ensures that the sample remains fixed during processing until embedding. From the viewpoint of arranging the work, it is preferable to use a cassette mold assembly as a container, which allows the sample to be embedded directly inside the container. This prevents additional manipulations and (use of?) the expensive equipment. In such container assemblies, the sample is immediately placed into an embedding mold, the mold is closed with a conventional cassette or its imitation, which rests against the mold edges; a porous material (Klinipath U.S. Pat. No. 9,116,090, IPC A61B10/00, 2015; Richard Allan Scientific U.S. Pat. No. 9,546,937, IPC A61B10/00, 2017) or a spring-loaded plate (Leica U.S. Pat. No. 9,097,629, IPC A61B10/00, 2015; U.S. Pat. No. 9,389,154, IPC G01N1/31, 2016) is used to press the sample to the bottom of the mold. After processing and cooling, the block with the sample and cassette is separated from the mold and sent for microtomy.

A feature of the auto-embedding system using cassette mold assemblies as a container is that, during processing, the tissue sample is pressed to the bottom of the mold, which hampers the exchange of liquid and necessitates the use of accelerated processing methods, e.g., using microwave irradiation.

In the listed projects of cassette mold assemblies, the mold is covered with either a conventional cassette or its imitation with a hard bottom. The hard bottom of the cassette does not follow the shape of the sample, which results in its compression and further deterioration of processing conditions.

Moreover, when performing simultaneous embedding, to maintain proper orientation, each cassette mold assembly should be placed into a separate cell of the sample basket, which requires a lot of space, thereby reducing the capacity and performance of the processor and hampering removal of the cassette mold after the paraffin has hardened.

An attempt to increase capacity and performance by stacking containers was implemented in a device for preparing tissue samples for histological examination (U.S. Pat. No. 4,569,647, IPC B29C41/00; G01N1/36, 1986), wherein a capsule containing two frames is used as a container, with their lumen being blocked by permeable porous partitions made of a non-woven material. In this case, one of the frames serves as a cover and has a labeling surface. This frame is essentially an imitation of the histology cassette housing. The second frame relates to the mold. A stepped notch is made on the upper and lower surfaces of the mold frame along its perimeter, which enables the connection with the cover frame (the cover frame is inserted into the upper notch), and the formation of a stack (when stacking the molds, a protruding part of the cover frame of the underlying capsule is placed into the notch on the lower surface of the mold frame). The tissue sample is placed at the bottom of the mold, covered with a sponge holding material and a cover, the capsules are stacked, and the stack is compressed by holding plates of the processing apparatus; the plates have holes connected to reagent tubes. After compression, a sealed channel covered by multiple permeable partitions of the capsules is formed inside the capsule stack; the reagent tubes open into the channel from above and below. Treatment fluids and melted paraffin are sequentially pumped through the channel; on completion of processing, pumping of paraffin stops, and the channel remains filled with paraffin, which is allowed to harden. The holding plates are then released, the stack is removed, and the capsules are separated. The mold frame is made of low-density polyethylene, which allows for slight elastic compression and slight deformation upon compression, when stacked covers and molds are held inside by a ratchet clamp assembly. The compression-induced deformation is reversed once the stack is released from the clamping assembly resulting in each mold being released from the hardened paraffin block. The paraffin block containing the sample is expected to remain connected to the labeled cover but not to the mold, since different frame materials are used.

The capsule stack as described in U.S. Pat. No. 4,569,647 can be processed in one processor type only, i.e., using forced reagent pumping through a channel (such a processor has not yet been created), since, in a conventional processor, the sealed channel would not allow efficient processing of the samples located in the middle of the stack. A long, sealed channel does not ensure uniform processing of all samples and free flow of the reagents to each sample when processed in a conventional processor. Due to the low stability caused by the alternation of rigid and elastic frames, sealing such a stack is unlikely, especially when the height of the stack exceeds the width of the capsule. To perform embedding, paraffin should be held in the channel of the container stack until it hardens, and since the container stack does not have a gap between the capsules for paraffin draining, the entire stack will be a paraffin monolith after hardening, and separating the blocks is hampered.

Moreover, in a stack, each cover is connected to two different molds containing different samples; the overlying mold is connected to the cover of the underlying capsule, thus simultaneously dismantling the stack and separating the blocks, which makes it impossible to initially dismantle the stack into separate containers, and then separate the blocks from the molds. This results in a high probability of sample confusion.

### SUMMARY

The invention is based on the task of creating a container, which could be suitable for efficient processing and impregnating of histological and biological samples, and subsequent embedding of blocks for microtoming.

The said task is solved by a container for processing and embedding histological samples configured to be stackable that allows treatment fluids to flow inside the stack, and comprising a housing with a frame connected to a base for placing a sample, and a removable cover with a frame covered by a permeable material, wherein the frame of the container housing is made of a material that is elastic and deformable under compression, the permeable material covering the cover frame is elastic, the housing base is made with a recess for placing the sample, and two opposite sides of the housing frame form side walls extending up and down from the base connection line, wherein their height exceeds the total of the depth of the sample recess, the thickness of the sample recess bottom, and the thickness of the container cover by at least 0.1 mm. Wherein a lock assembly is arranged on the upper and lower edges of the base side walls.

### DETAILED DESCRIPTION

Preferably, the lock assembly includes a latch located on the upper edge of each side wall of the housing, which has a flat surface and a notch on the outside, and a convex element located at the internal side in the recess made on the lower edge of each side wall, which upon stacking engages with the latch of the underlying container. The latch has a cross-sectionally rounded part protruding inside the container above the cover. The cover frame is made as a conventional histological cassette. The height of the cover frame in the container closed with the cover exceeds the height of the housing frame, except for the side walls, by at least 1 mm.

The permeable elastic material covering the cover frame may be a polymer mesh. The permeable elastic material covering the cover frame may also be a perforated film. The container housing can be made of a paraffin-repellent material. The container housing can be made of a transparent material. If necessary, the container further comprises an element made of a porous elastic material that presses down the sample.

### BRIEF DESCRIPTION OF THE DRAWINGS

The claimed container is illustrated in an axonometric view in FIGS. 1-9.

FIG. 1 is a general view of a container with a cover.

FIG. 2 is a bottom view of a container with a cover (from the bottom side).

FIG. 3 is a container housing with a sample recess.

FIG. 4 is a cover with an elastic membrane.

FIG. 5 is the reverse side of the cover.

FIG. 6 is a cross-section of the assembled container.

FIG. 7 is a sectional view of a container containing a sample and a porous retaining pad.

FIG. 8 is the stacked containers (a stack).

FIG. 9 is a scheme demonstrating the treatment fluid supply to a container stack during the sample processing.

### DETAILED DESCRIPTION OF THE PREFERRED EMBODIMENTS

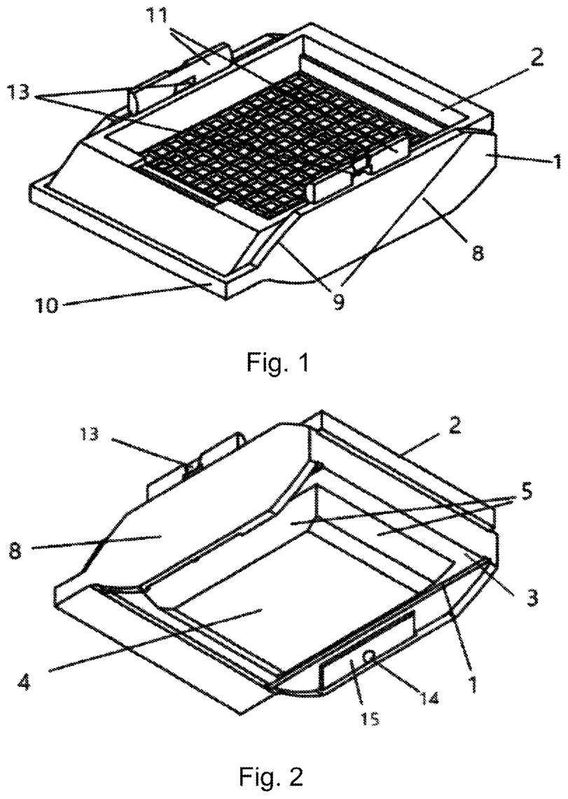

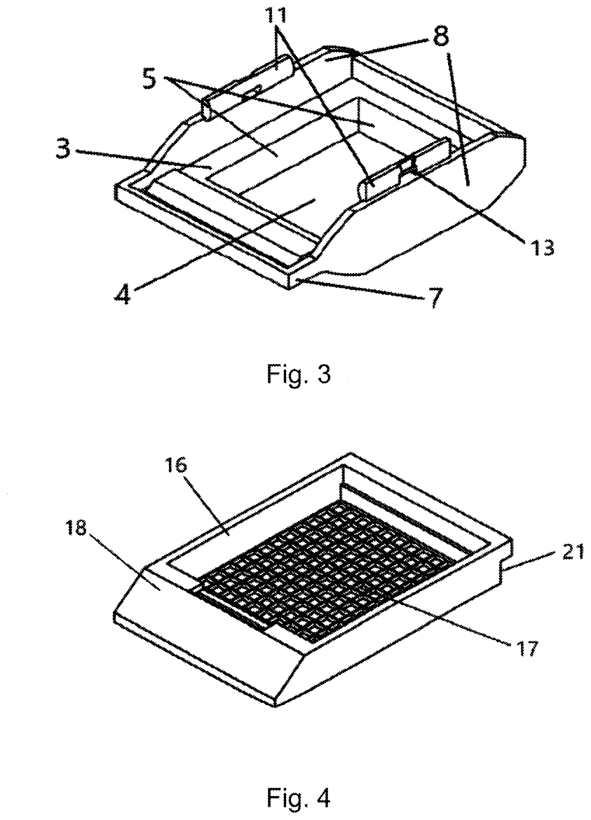

The container for processing and embedding histological samples comprises (FIGS. 1-6) a housing 1 accommodating a tissue sample for examination, which is a filling mold, and a cover 2 provided as a conventional histological cassette. The housing comprises (FIG. 3) a rectangular base 3 having a recess 4 forming edges 5 around the perimeter and a transverse rectangular protrusion 6 in the front part of the housing base 3 configured to engage with the cover 2 and ensuring the longitudinal orientation of the cover. The container base with a sample recess is made of a paraffin-repellent material to ensure easy removal of the finished block. The base 3 is framed with a frame 7 forming the housing walls. The front and rear walls formed by the frame protrude upward from the base, and their height is less than that of the cover by at least 1 mm. The longitudinal side walls 8 are significantly higher than the rest of the frame, have chamfers 9, are made symmetrical, and protrude from both the top and bottom of the frame. The height of the side walls exceeds the total height of the sample recess, the recess bottom thickness, and the container cover thickness by at least 0.1 mm (FIGS. 2 and 6). At the front, the housing frame 7 protrudes and forms a holder 10 for easy gripping of the container (FIG. 3).

A lock assembly is made on the upper and lower edges of the housing side walls, which allows to fix the containers upon stacking. In this regard, on the upper edge of each side wall there is a protruding latch 11, which has a flat surface on the outside, and a notch 13 for engaging with a convex element 14 located in the corresponding recess 15 arranged at the internal side in the lower part of the side wall of the overlying container upon stacking (FIGS. 2 and 6). Therefore, latches of the lower container are placed in the recess 15 upon stacking. The ease of stack assembling is ensured by the lock assembly and the smooth outer side surface of the latch.

The latch 11 has a cross-sectional rounding 12 which protrudes inside the container and is intended for fastening the cover in the container. The latches with their protruding parts having a rounding 12 hold the cover 2 inside the housing frame 7, which is important during processing and embedding.

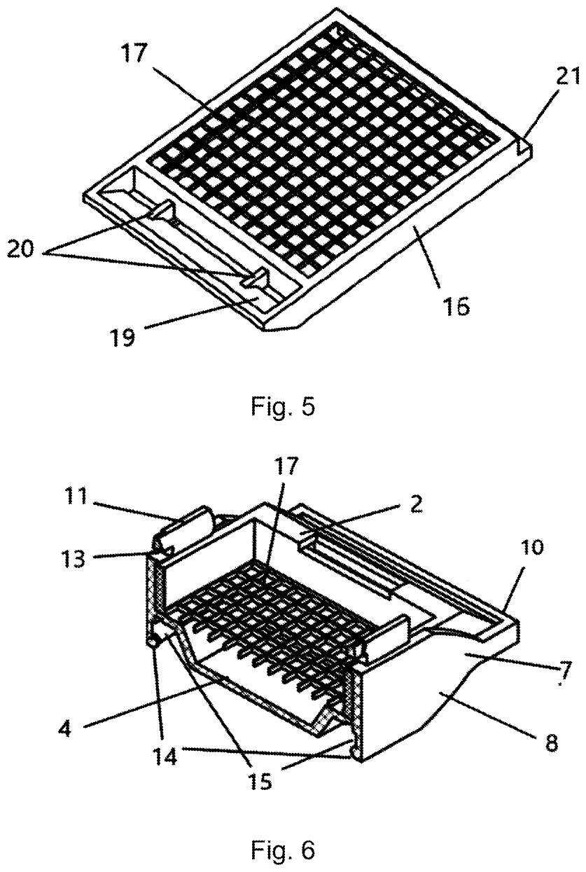

The cover 2 (FIGS. 4 and 5) is made as a rectangular frame 16 overlain with a permeable elastic partition 17 made of a polymer material. A section of the cover frame is arranged with a chamfer 18 in its front part and has a notch 19 on the bottom side for its corresponding rectangular protrusion 6 in the front part of the housing base. In a conventional cassette, the chamfer provides a reliable fixation in the microtome clamp and serves as a labeling surface; the process notch prevents deformation during molding, and connections 20 therein ensure structural rigidity. The rectangular cover 2 is placed in the housing 1 resting on a horizontal surface along the perimeter of the housing base 3 (FIGS. 1 and 6). A stepped notch 21 (FIG. 5) is provided on the rear side of the cover frame, from the bottom side, wherein the assembled part of the cover frame protrudes from the chamfers of the housing frame side walls to form a rectangular shape at the rear in the upper part of the container. The height of the cover frame in the container exceeds that of the front and the rear walls formed with the mold frame by at least 1 mm.

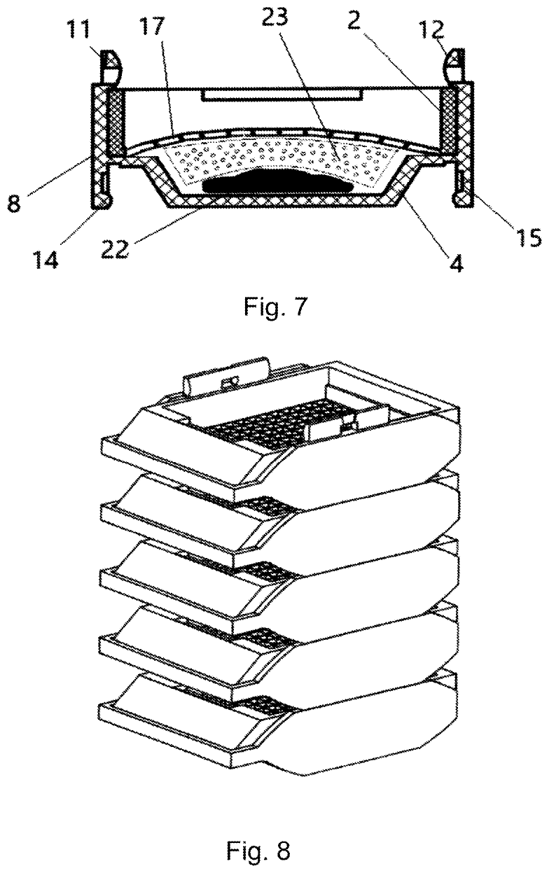

When using the claimed container, a sample (a tissue fragment) obtained by cutting is placed at the bottom of the recess 4 of the container base 3 (FIG. 7) so that the surface to be examined is pressed to the recess bottom. The base 3 is covered with the cover 2, wherein the sample to be examined is pressed down with the cover to the recess 4 bottom. If the sample thickness is less than the recess 4 depth, before installing the cover 2, the sample 22 is covered with a retaining pad 23 (which is made of porous high-density polyethylene, for example) that is embedded and cut along with the sample. The entire container is made of a polymer material (thickness limit is 0.1-1.5 mm) that allows for elastic expansion of the side walls 8 under the pressure of the inserted cover 2. In particular, the container housing can be made of polyethylene terephthalate (PET), which is a transparent material that allows checking the sample position after the container has been assembled. The cover, where the inscription is applied on, can be made of opaque polystyrene, for example.

The cover 2 is inserted from above with applying light pressure on the frame 16 of the cover from above, wherein, during the installation, the longitudinal sides of the cover 2 frame 16 located parallel to the side walls 8 of the housing 1 put pressure on the inwardly protruding rounded parts 12 of the latches 11. Due to the latch rounding 12, the cover 2 can be easily pressed through them and snaps shut. The latches 11 with protruding rounded parts 12 hold the cover 2 in the frame 7 of the housing 1, thus securely fixing them during the tissue sample processing.

The closed containers are stacked (FIG. 8) according to the height of the processor's basket cell. Upon stacking the containers, the latch 11 engages with the convex element 14 located in the recess 15 in the lower part of the side wall of the overlying container (FIGS. 2 and 6). Therefore, latches of the lower container are placed in the recess 15 upon stacking. The stacks are placed into the baskets so that the container recesses 4 are oriented in the same direction, and then the filled baskets are loaded into the processor.

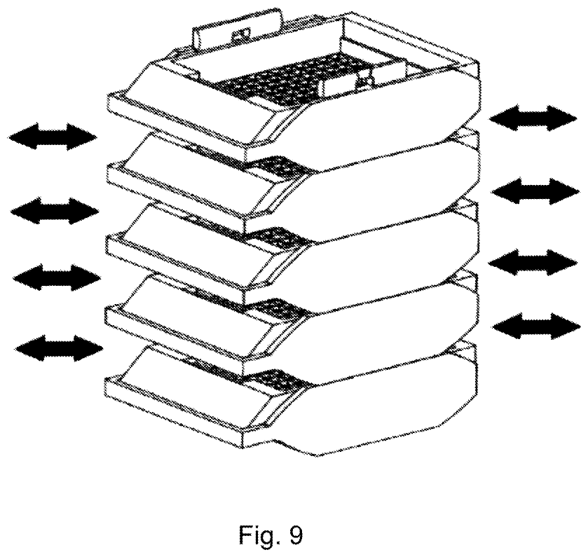

When processing in the processor, the fluid is exchanged through the gaps in the stack formed by the container's design (high side walls in the mold frame made with chamfers; a cover that is higher than the front and the rear walls of the housing). Treatment fluids are supplied through intervals between containers (FIG. 9).

If the processor is adapted to change the orientation of the baskets during processing (for example, the processor according to PCT Application WO2019216783(A1) published on Nov. 14, 2019), then, upon completion of the process, ready, cooled blocks are obtained, otherwise the baskets containing the impregnated samples are transferred into an external paraffin station for embedding and subsequent cooling. By the way, since the sample is placed into the recess of a mold with a solid bottom, paraffin does not pour out, unlike the prototype mold with a porous bottom.

After the paraffin has hardened, the container stacks are removed from the basket cells, and the containers are separated. The containers are separated with little effort anywhere due to the material's elastic compression (when a tearing force is applied, the element 14 bends the latch 11 inwardly due to its convex shape, so the stack can be dismantled).

After being separated from the stack to remove the cover-a cassette with a paraffin block-lower parts of the container's side walls 8 are elastically compressed (squeezed), wherein, respectively, the upper parts of the side walls 8 are moved apart together with the latches 11, and the cover 2 is released and removed along with the embedded sample.

The design of the claimed container makes it possible to process and impregnate histological samples with high efficiency and performance, to embed blocks in the same apparatus in the cassette mold assemblies, which prevents the lengthy and labor-intensive procedure of manual embedding of the samples, as well as also to reduce the probability of errors in sample identification during the operation. The cover frame has a shape of a conventional cassette, which allows the use of all devices designed for the cassettes: a microtome clamp, a labeling printer, and archiving boxes.

Since the volume of the chamber and the treatment fluid is limited, the design of the claimed container allows the samples to be placed as compactly as possible to achieve high performance. The capacity and performance are increased by enabling the containers to stack while securely fixing them. At the same time, which is especially important, when auto-embedding, the cassette molds are oriented in a certain way rather than placed “in bulk.” The protrusion in the front part of the container housing base ensures reliable engagement with the cover and its longitudinal orientation. The entire stack is removed from the cell. There are fewer contact surfaces with the basket cell, and, hence, less paraffin will stick between the basket and the stack, which makes it easier to remove the stack. The design with high side walls guarantees the presence of a gap between the containers to drain the excess paraffin; therefore, after it hardens, the containers are secured only with the lock assembly using latches, but the paraffin block itself is not involved in securing. Therefore, the availability of a sample recess, an impenetrable solid bottom of the mold, and the excess of the side wall height over the total of the thickness of the cover, and the depth and thickness of the recess bottom ensures that the mold does not contact the cover of an adjacent container. Moreover, the rest of the mold frame (except for the high side walls) is lower than the cover frame and provides a direct fluid access to each sample.

Furthermore, the claimed design provides a simple and convenient removal of the block containing the sample from the mold. Since only molds are involved in the stack formation, and the covers with samples do not contact other molds and cannot be removed until the stack is dismantled into separate containers (unlike the stack in the prototype, where each cover is connected to two different molds comprising different samples), the probability of confusion with the sample labeling is reduced. The use of a paraffin-repellent mold material also facilitates the release.

As mentioned above, either a spring-loaded plate or a porous material pressed with the rigid cassette wall is typically used to hold the tissue sample at the bottom of the mold. The plate does not follow the shape of the sample, so the retention may be inefficient if the piece has a complex shape and varying thicknesses, or if the sample is fragmented (then only the largest fragments will be pressed).

In case of a porous material, it follows the shape of the sample, that is, the retention is efficient; however, in the area of the highest sample thickness, the pressing material is compressed between the tissue and the cassette wall, thereby disrupting the exchange of fluid. The claimed invention employs two elastic elements: a porous material of the pressing element and an elastic material covering the cassette frame, which provides efficient pressing down but no squeezing, and allows uniform high-quality processing of the entire sample.

The container can be made via 3D printing or molding. A batch of containers was manufactured and tested in the Leica ASP 6025 processor.

The claimed device for processing and impregnating histological and biological samples can be used in histology (pathology) and cytology laboratories as well as in any other biological and medical institutions engaged in microscopic examination of tissues and cells.

1. A container for processing and embedding histological samples configured to be stackable, which allows treatment fluids to flow inside the stack and comprises a housing with a frame connected to a base for accommodating the sample, as well as a removable cover with a frame covered with a permeable material, wherein the frame of the container housing is made of a material that is elastic and deformable under compression, characterized in that the permeable material covering the cover frame is elastic, the base of the housing is made with a recess for receiving the sample, and two opposite sides of the housing frame form side walls extending up and down from the base connection line, wherein their height exceeds the total of the sample recess depth, the thickness of the sample recess bottom, and the thickness of the container cover by at least 0.1 mm, wherein a lock assembly is provided on the upper and lower edges of the side walls of the base.

2. The container according to claim 1, characterized in that the lock assembly includes a latch located on the upper edge of each side wall of the housing, which has a flat surface and a notch on the outside, and a convex element located at the internal side in a recess made on the lower edge of each side wall, which, when stacked, engages with a latch of the underlying container.

3. The container according to claim 2, characterized in that the latch has a cross-sectionally rounded part protruding inside the container above the cover.

4. The container according to claim 1, characterized in that the cover frame is made as a conventional histological cassette.

5. The container according to claim 1, characterized in that the height of the cover frame in the container closed with a cover exceeds the height of the housing frame, except for the side walls, by at least 1 mm.

6. The container according to claim 1, characterized in that the permeable elastic material covering the cover frame is a polymer mesh.

7. The container according to claim 1, characterized in that the permeable elastic material covering the cover frame is a perforated film.

8. The container according to claim 1, characterized in that the container housing is made of a paraffin-repellent material.

9. The container according to claim 1, characterized in that the container housing is made of a transparent material.
